(19) United States
(12) Patent Application Publication
(10) Pub. No.: US 2015/0182987 A1
(43) Pub. Date: Jul. 2, 2015

(54) MOVABLE MASK FOR A THERMAL AND/OR KINETIC COATING SYSTEM

(71) Applicant: WIELAND-WERKE AG, Ulm (DE)

(72) Inventors: Wolfram Schillinger, Ulm (DE); Thomas Klassen, Wentorf (DE); Kerstin-Raffaela Ernst, Hamburg (DE)

(21) Appl. No.: 14/408,496

(22) PCT Filed: Jul. 10, 2013
(86) PCT No.: PCT/EP2013/002025

§ 371 Date: Dec. 16, 2014

(30) Foreign Application Priority Data
Aug. 30, 2012 (DE) 10 2012 017 186.2

(51) Int. Cl. B05C 21/00; B05D 1/32; B05C 5/02; B05D 1/02

(52) U.S. Cl. CPC B05C 21/005; B05D 1/02; B05D 1/32; B05C 5/025

(57) ABSTRACT

The invention relates to a mask for a coating system having a covering device for an area not to be coated of a substrate to be coated, having a working side exposed to the material flow of the coating material, wherein the covering device for the area not to be coated is comprised of at least one disk that can be rotated, the disk upper side of which is positioned vertically to the material flow of the coating material. A further aspect of the invention includes a thermal and/or kinetic coating system having at least one spray device, and a corresponding method for producing a coated substrate.

The invention relates to a mask for a coating system according to the preamble of claim 1, to a coating system according to the preamble of claim 9, and to a method for producing a coated substrate by means of a coating system.

Cold-gas dynamic spraying is a high kinetic energy coating process in which with the aid of inert gases and pressures of up to 40 bar and gas velocities way above 1000 m/s metal particles are very powerfully accelerated. The particles are applied in the solid state to the component surface, wherein the substrate is not fused. During the impinging of the coating particles upon the substrate which is to be coated, the particles, on account of the high velocity, are deformed in the same way as the substrate surface so that there occurs merging of the materials and adhesion of the coating material. In this case, compact and strongly adherent coatings with a very low oxide content are created.

It is frequently necessary to coat substrates only in partial areas of the surface. To this end, masking technologies, by means of which the areas of a substrate surface which are not be coated are covered, are already known. Conventional covers, such as adhesive tape or silicon masking, are as a rule inadequate since they cannot withstand the high particle velocities. On the other hand, stable materials, such as metals or plastics, are themselves coated so that a strongly adherent coating is produced on a mask, which leads to the masks having to be disposed of after use.

As a result of continuing developments, multiply usable masks are also known in the meantime. Thus, a mask for the kinetic cold-gas dynamic compacting for multiple use is to be gathered from printed document DE 10 2008 056 652 A1. Proposed in this context is a mask which on the side facing a coating source is designed to be very hard in such a way that during the applied kinetic cold-gas dynamic compacting no surface deformation, i.e. no plastic deformation, of the working side can take place. Consequently, the effect of the surface material of the mask and the impinging coating particles being deformed and being merged into each other is avoided and they therefore form a hard coating. The mask can be cleaned after use and used again.

A covering device for the coating of components by means of cold kinetic compacting or kinetic cold-gas dynamic spraying is known from printed document DE 10 2008 025 510 A1. Using the covering device, an area of a surface of the component which is to be coated is again covered. The covering device is profiled as a mask in such a way that in the area in which no coating is to take place the surface has a sawtooth-like structure. The intended effect of this surface is that particles of a coating material are deflected from the component so that this material does not adhere to the surface structure.

A mask for a coating system with a covering device as rotating stenciling disks is known from printed document DE 692 922 A and DE 82 10 872 U1. The stenciling disks, which are arranged one above the other and at an acute angle to each other, shadow the area of a workpiece which is not to be coated.

The invention is based on the object of further developing a mask for a coating system, such as the cold-gas dynamic spraying, in which a multiple or continuous use is ensured. A production method is also to be specified.

The invention, with regard to a mask, is reflected by the features of claim 1. A further aspect of the invention, with regard to a coating system, is reflected by the features of claim 9 and, with regard to a method for producing a coated substrate, is reflected by the features of claim 16. The further related claims relate to advantageous forms and developments of the invention.

The invention includes a mask for a coating system with a covering device of an area which is not to be coated of a substrate to be coated with a working side which is exposed to the flow of the coating material, wherein the covering device of the area which is not to be coated consists of at least one rotatable disk, the upper side of which is perpendicular to the flow of the coating material.

The invention in this case is based on the consideration that the mask in the region of the covering device is continuously coated with coating material during the deposition process. By the rotation of a disk, the surface coating on the covering device is continuously guided out of a spray jet at a point outside the influence of the jet at which the surface can be cleaned again. The spray jet only impinges upon the substrate at the points which are freed by the covering device. To this end, at least one disk is provided. An individual disk then has suitable openings through which the spray jet can penetrate through to the substrate. In the case of two or more rotating disks, these are at a distance from each other so that a coating gap frees the flow of the coating material onto the substrate surface. As a result, locally continuous coatings are produced on the surface for example in the throughput direction of a strip material. The coating gap can be adjusted to the desired dimension by means of adjustable disks.

The rotatable disk which is used as a covering device has an upper side, an end face and an underside. The disk upper side in this case is perpendicular to the flow of the coating material and is exposed to this. However, slight inclinations from the perpendicular can also be provided and be acceptable providing the shadowing effect of a disk upper side is still ensured. The disk underside lies in the shadowed area. Since the coating material is usually deposited via a bundled jet, only the outer edge region on the upper side of the rotatable disk is consequently coated by coating material. In the case of a plurality of disks, the upper sides or undersides are arranged adjacently in one plane. A disk rotation is carried out in each case via rotational axes which extend parallel to each other and are laterally spaced apart. The rotational axes are at such a distance apart that a gap is formed between the respective disk end faces, through which gap the coating material passes and reaches the working side of the substrate. In other words, the spacing of the rotational axes corresponds to the sum of the disk radii, inclusive of the deposition gap between the disks which is to remain.

In the case of the substrate which is to be coated it is usually plates, bars or endless strip material which is guided directly through beneath the disks which rotate during use. The distance from the rotating disks is correspondingly minimized.

The rotatable disks, with regard to their radius relative to the spray jet, are selected to be of such size that the curvature of the outer edge of the disks has no significant influence upon the edge region of the deposition zone. In other words, the spray jet is locally arranged so that the covering edge regions of the mask act like shadows which extend parallel to each other. In this way, a sharp contour line in relation to the uncoated areas is formed in the edge regions of the coating. The rotational speed of the rotating disks is matched to the quantity of coating material in this case. The rotational direction of a disk in the shadow zone is usually selected to be in the movement direction of the strip so that strip and disks are unidirectional. The coating material which is deposited on the surface of the covering device only has a small thickness in this case so that the coating characteristic is not altered as a result.

The specific advantage is that as a result of the present masking technology a continuous production, especially of strip material, is particularly economical. For example, a copper or copper alloy strip can be provided over the whole surface or partially with an aluminum coating in this way. Such coating systems are used for example as selective aluminum-coated copper strips as battery cell connectors. With this technology, it can also be realized that the coating material is not fused and so the risk of a possibly disruptive phase conversion does not occur. With deposition under suitable parameters, an extremely low thermal loading of the substrate also takes place. In this way, almost pore-free coatings can be produced.

In a preferred embodiment of the invention, a thermal and/or kinetic coating system, especially a cold-gas dynamic spraying system can be used. The term thermal and/or kinetic spraying system relates to deposition devices according to the principle of flame spraying, detonation spraying, plasma spraying, laser spraying, electric arc spraying, cold-gas dynamic spraying, plasma-transfer arc coating (PTA) or high velocity oxygen flame spraying (HVOF). In the case of these methods, the coating material is deposited by means of a spray jet.

A cleaning device can be advantageously arranged on each rotatable disk on the side facing away from the substrate. The one part of the spray jet, which does not serve for coating the substrate, is for the most part shadowed by the covering device and is also deposited on this. Material of the spray jet is consequently also continuously deposited on the surface of the rotatable disk. As a result of the rotation of the disk, the deposited material reaches a position which is a distance away from the substrate, where a cleaning device cleans the coated surface. The cleaning can be carried out on the basis of a mechanical removal by brushing, by grinding, by lifting off by means of a blade or even only by wiping. Each cleaning device usually had a storage vessel or a suction device which receives the material removed from disk surface or immediately transports it away. As a result of the further rotation of the rotatable disk, the once-cleaned surface again reaches the region of the spray jet where it fulfills its function as a covering device. In this way, a rotatable disk is continuously coated on the one side and continuously cleaned on the other side so that a continuous use of such a mask is made possible.

In a preferred embodiment of the invention, an arrangement can be made for two contra-rotating disks which are spaced apart so that a coating gap remains. In the case of the preferably applied strip material, the disks are arranged in a horizontally lying manner above the strip material and are fastened in each case on a rotating axis. The disk radius is selected so that a certain part of the substrate is kept free and can be coated by the spray jet. Partial coatings, which extend continuously over the longitudinal axis of the strip, are customarily produced in such an arrangement.

Moreover, it is also possible that the rotatable disks have a coating gap which is variably adjustable within the width of a coating which is to be produced. In this context, variable means that the rotational axes of the rotating disks can be shifted transversely to the strip direction and in this way the coating gap can be selected to be larger or smaller without disks having to be exchanged.

In an advantageous embodiment of the invention, the at least one rotatable disk can have a corrugated or serrated outer contour and/or openings for selective deposition. A corrugated or serrated outer contour is used especially in the case of a covering device with two disks.

As a result of such an outer contour, the gap size can be varied during a coating process in order to achieve specific geometries of the deposited coatings during the deposition process. Openings in the rotatable disk, like a diaphragm, serve for producing round or oval deposits, or deposits which are defined in another way. In this way, a large number of different local or continuous cover coatings can be produced on strips.

The surface of a rotatable disk preferably has a poor adherence for the sprayed material. In order to be able to continuously clean a disk during the treatment process, it is advantageous that the surface of a disk easily frees again the sprayed material deposited there. Therefore, for example even wiping can suffice in order to regenerate the disk surface again.

In an advantageous embodiment of the invention, at least the surface of the rotatable disks can consist of steel, hard metal, ceramic, glass, diamond-like amorphous carbon (DLC), hard chromium, or graphite. Such materials have a sufficient degree of hardness so as not to be deformed under the spray jet on the surface. The stated materials are especially also heat resistant to the extent that they are stable in relation to the temperature of the spray jet and do not feature any partial melting or fusion phenomena. Moreover, the materials are extremely hard in comparison to the coating material. In this way, the disks can have a long service life in a continuous production without having to be exchanged.

A further aspect of the invention includes a thermal and/or kinetic coating system with at least one spraying device, wherein provision is made for a transporting device which linearly and continuously guides a substrate which is to be coated beneath the at least one spraying device. Furthermore, an arrangement is made for a mask according to the invention with a covering device of an area which is not be coated of a substrate which is to be coated. Alternatively, the mask can also be constructed as a continuously revolving tape mask.

The invention in this case is based on the consideration that such thermal and/or kinetic coating systems, especially cold-gas dynamic spraying systems, are able to provide strip-like substrates with a coating in an economical continuous process. As a result of this, for example copper strips, selectively coated with aluminum, for battery cell connectors shall be able to be produced.

The at least one spraying device can preferably be stationary. Particularly for small deposition surfaces, it can be sufficient for example to conduct an adequate coating with a cold-gas dynamic spraying device. In the case of a stationary arrangement, however, the spray jet has to have such a size that it can produce the desired coating on the substrate through the mask. Stationary devices of this type are advantageous in any case compared with movable systems since these stationary devices require no further provisions for movement and control of the spraying head.

In an advantageous embodiment of the invention, the at least one spraying device can be oscillated perpendicularly and/or parallel to the substrate throughput direction. A movement of the spraying device takes place in this case in a very limited manner in one or two spatial directions. With an oscillation conducted perpendicularly to the substrate throughput direction, a larger substrate area across the strip width is covered by the spray jet. A particular feature has the oscillation of the spray jet conducted parallel to the substrate throughput direction. In this case, a spray jet is matched to the movement characteristic of the covering device and of the substrate material which is to be coated. If, for example, a spray jet is located by the mask directly in a deposition position on the substrate, then this can be tracked by the substrate movement so that a longer coating time is made available. To this end, the throughput speeds of the substrate, the rotational speeds of the covering device and the tracking of the spray jet are accurately matched to each other.

In the case of the thermal and/or kinetic coating system according to the invention, an arrangement can advantageously be made for a mask according to the invention with a covering device of an area which is not be coated of a substrate which is to be coated. In practice, to this end the masks which are used are to be chosen in each case for the coating characteristic and in this case to correlate the throughput speed of the substrate beneath the spray jet and also the rotation characteristic of the covering device.

Alternatively, in a preferred embodiment in the case of the thermal and/or kinetic coating system according to the invention, a continuously revolving tape mask can be constructed with a covering device of an area which is not to be coated of a substrate which is to be coated. Tape masks can be endless tapes which on the one hand, as a covering device, determine the deposition characteristic on the substrate and on the other hand are guided along the entire device so that these can also be subjected to cleaning. Such tape masks, by means of deflecting and guiding devices, can also be removed from the coating zone by such a distance that the surface cleaning can be conducted by means of a cleaning device without any problem. Furthermore, tape masks which are designed so that they can be removed from the system for cleaning, are also envisaged. Specific forms of rings or tapered rings are also conceivable.

In an especially preferred embodiment, a mechanical pretreatment device can be arranged to precede the spraying device, as seen in the direction of strip movement. Such pretreatment devices serve for the pretreatment of a substrate surface on which the coating material is to be deposited. In this way, the substrate surfaces are first of all cleaned and, as a result of the mechanical action, are also slightly roughened in most cases. The coating material experiences better adhesion on the roughened surfaces.

In a further advantageous embodiment of the invention, at least one annealing device can be arranged to follow the spraying device in the substrate throughput direction. Such temperature treatments are suitable for curing possibly occurring stress states on the boundary surface of the deposited material towards the substrate. On the other hand, temperature treatments can also advantageously influence the phase state of the respective joining partner.

At least one cold rolling device can advantageously be arranged to follow the spraying device, as seen in the substrate throughput direction. This so-called after-rolling of the coatings has the result that possibly still remaining pores or other types of cavities can be sealed off. Furthermore, the effect of a rolling process is that the surface of the deposited material is smoothed and, moreover, the adhesion to the substrate surface is improved.

In a preferred embodiment of the invention, a milling device can be arranged to follow the spraying device, as seen in the strip movement direction. Milling devices serve for the aftermachining of a possibly still rougher surface. In particular, the coating thickness can also be accurately adjusted as desired as a result of the milling process.

A further aspect of the invention includes a method for producing a coated substrate by means of a thermal and/or kinetic coating system, characterized by the following steps:
optionally pretreating the working side of the substrate;
linear and continuous guiding through of the substrate beneath a spraying device, wherein the working side (21) of the substrate (20), by means of a mask (1) consisting of at least one rotating disk (3), the upper side of which is perpendicular to the flow of the coating material, or by means of a continuously revolving tape mask in the region of a spray jet (12), is partially covered and only partially subjected to deposition;
optionally in each case, at least one annealing, at least one cold rolling and a milling of the coating which is applied to the substrate.

The invention in this case is based on the consideration that the simplest form of a selective deposition is that a substrate is linearly and continuously drawn through beneath the spray device. By means of this procedure, deposition can already be carried out partially or even over the whole surface on the working side of the substrate. The optional method steps of a pretreatment or aftertreatment of an already deposited coating serve for improving the adhesion or the surface qualities of the coating.

A linear and continuous guiding through of the substrate beneath a spraying device can advantageously be carried out, wherein the working side of the substrate, by means of a mask consisting of at least one rotating disk, or by means of a continuously revolving tape mask in the region of the spray jet, is partially covered and only partially subjected to deposition.

By means of additional masks, locally deposited coatings with a significantly higher quality can especially be produced. The edges of locally implemented deposits are formed correspondingly sharp. In particular, combinations of different covering devices provide the possibility of realizing punctiform or continuously strip-form deposits. Combinations of both are also conceivable.

Exemplary embodiments of the invention are explained in more detail with reference to the schematic drawings.

In the drawing:

FIG. 1 schematically shows a top view of a mask with a disk, and a substrate,

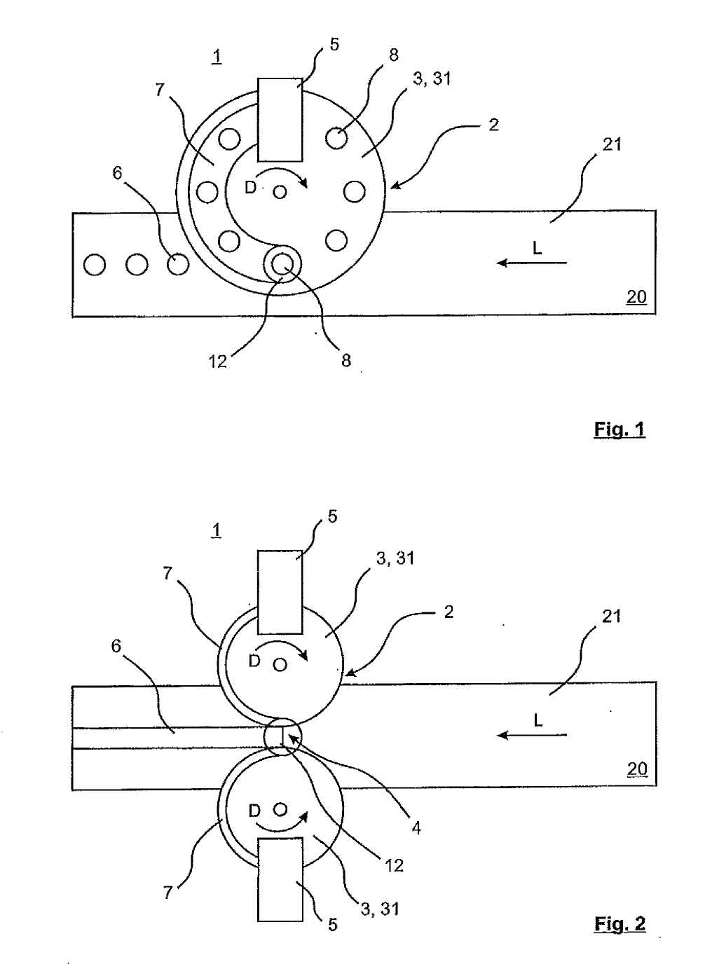

FIG. 2 schematically shows a top view of a mask with two disks, and a substrate,

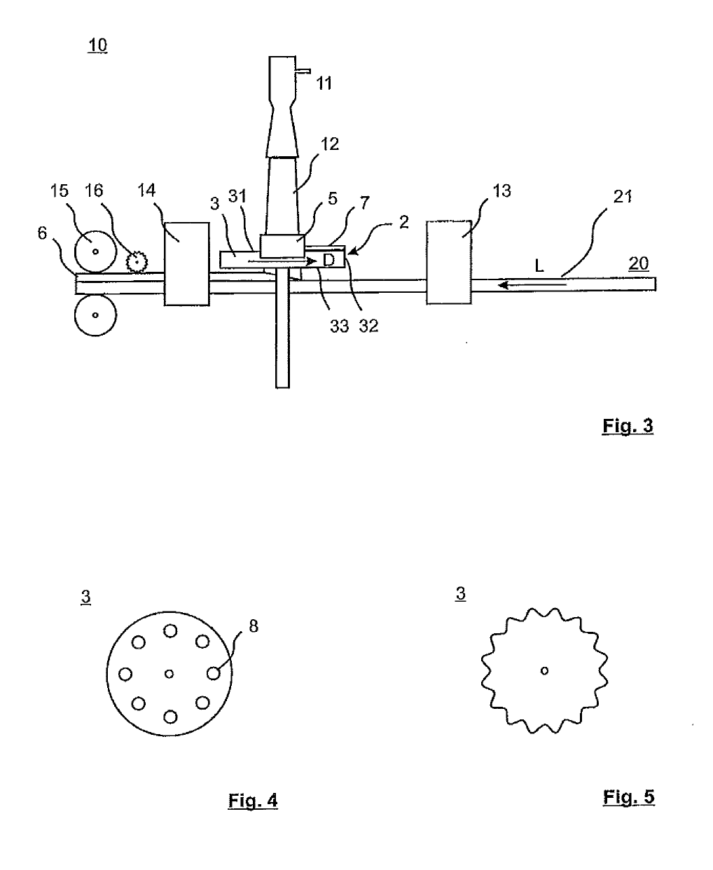

FIG. 3 schematically shows a side view of a cold-gas dynamic spraying system with substrate,

FIG. 4 schematically shows a disk as a covering device with openings, and

FIG. 5 schematically shows a disk as a covering device with a serrated outer contour.

Parts which correspond to each other are provided with the same designations in all the figures.

FIG. 1 schematically shows a top view of a mask 1 with a disk 3 and a substrate 20. In the case of the disk 3, it is the covering device 2 which effects the partial coating and is arranged between the spray jet 12 and the working side 21 of the substrate surface. The disk 3, extending from the upper side 31, has numerous openings 8 around the circumference through which the spray jet 12 can penetrate. At the point in time at which an opening 8 travels through the spray jet 12, the substrate 20 is locally coated. In this case, the rotational direction D and the substrate throughput direction L are matched to each other so that the spray jet 12 deposits circular coatings 6 on the substrate 20 at constant distances. At the points at which there are no openings 8, the spray jet 12 is intercepted by the disk 3 and the coating 7 is produced on the disk surface. Further in the sequence, the coating 7 is removed again from the disk surface by the cleaning device 5. The working side 21 of the substrate 20 is not additionally pretreated in this case.

FIG. 2 schematically shows a top view of a mask 1 with two disks 3, and a substrate 20. The disks 3 themselves, as a covering device 2, have opposed rotational directions D. Both disks 3 are arranged outside the substrate 20 on a rotational axis, and with regard to radius are selected so that a coating gap 4 remains between the two disk edges. The spray jet 12 impinges upon the working side 21 of the substrate 20 in the region of the coating gap 4. In this case, a strip-like coating 6 is produced on the substrate 20. By rotation of the two disks 3 in the rotational direction D, the portion of the coating 7 on the disk upper side 31 is guided away from the spray jet 12 and removed again from the disk surface in the respective cleaning devices 5.

FIG. 3 schematically shows a side view of a cold-gas dynamic spraying system 10 as a thermal and/or kinetic coating system with substrate 20. Arranged in series in the substrate throughput direction L is first of all a pretreatment device 13 for cleaning the working side 21. After the substrate cleaning, the coating is carried out by means of the spray device 11. The spray jet 12 is again only partially allowed through onto the working side 21 of the substrate 20 owing to the arrangement of the disk 3 as a covering device 2. The shadowed portion of the coating 7 on the disk upper side 31 is again removed by means of the cleaning device 5. The disk end face 32 and also a disk underside 33 is not coated by the coating material. The coating 6 on the substrate is subsequently heat-treated by means of an annealing device 14 and after that the oxide formed on the surface is removed by means of a milling device 16. For compacting the coating 6, the coating is then further treated by means of a cold rolling device 15.

FIG. 4 schematically shows a disk 3 as a covering device with openings 8. In this case, the openings are ultimately holes which pass axially through the disk. Depending on the deposition characteristic, oval, rectangular or other geometries can naturally also be introduced into the disk 3.

FIG. 5 schematically shows a disk 3 as a covering device with a serrated outer contour. This second variant is suitable for a mask in which at least two disks are used. As a result of the serrated or corrugated structure, the spray jet is shadowed during the deposition so that the serrated contour is also reproduced on the substrate surface. Combinations of the openings according to FIG. 4 and the serrated outer contour according to FIG. 5 are also conceivable. In this way, strip-like deposits can be combined with punctiform local deposits on the substrate surface.

### LIST OF DESIGNATIONS

1 Mask
2 Covering device
3 Disk
31 Disk upper side
32 Disk end face
33 Disk underside
4 Coating gap
5 Cleaning device
6 Coating on substrate
7 Coating of the disk
8 Openings
10 Cold-gas dynamic spraying system, thermal and/or kinetic coating system
11 Spraying device
12 Spray jet
13 Pretreatment device
14 Annealing device
15 Cold rolling device
16 Milling device
20 Substrate
21 Working side
L Substrate throughput direction
D Rotational direction

1. A mask for a coating system with a covering device of an area which is not to be coated of a substrate which is to be coated, with a working side which is exposed to the flow of the coating material,
wherein
the covering device of the area which is not to be coated consists of at least one rotatable disk, the upper side of which is perpendicular to the flow of the coating material.

2. The mask as claimed in claim 1, characterized by a thermal and/or kinetic coating system, especially a cold-gas dynamic spraying system.

3. The mask as claimed in claim 1, wherein a cleaning device is arranged on each rotatable disk on the side facing away from the substrate.

4. The mask as claimed in claim 1, wherein an arrangement is made for two contra-rotating disks which are spaced apart so that a coating gap remains.

5. The mask as claimed in claim 4, wherein the rotatable disks have a variably adjustable coating gap within the width of a coating which is to be produced.

6. The mask as claimed in claim 1, wherein the at least one rotatable disk has a corrugated or serrated outer contour and/or openings for selective deposition.

7. The mask as claimed in claim 1, wherein the surface of a rotatable disk has a poor adhesion for the sprayed material.

8. The mask as claimed in claim 7, wherein at least the surface of the rotatable disks consists of steel, hard metal, ceramic, glass, DLC, hard chrome or graphite.

9. A thermal and/or kinetic coating system with at least one spraying device, wherein
provision is made for a transporting device which linearly and continuously guides through a substrate which is to be coated beneath the at least one spraying device, and
arrangement is made for a mask with a covering device of an area which is not to be coated of a substrate which is to be coated, as claimed in claim 1, or as a continuously revolving tape mask.

10. The thermal and/or kinetic coating system as claimed in claim 9, wherein the at least one spraying device is stationary.

11. The thermal and/or kinetic coating system as claimed in claim 9, wherein the at least one spraying device can be oscillated perpendicularly and/or parallel to the substrate throughput direction (L).

12. The thermal and/or kinetic coating system as claimed in claim 9, wherein a mechanical pretreatment device is arranged to precede the spraying device, as seen in the strip movement direction (L).

13. The thermal and/or kinetic coating system as claimed in claim 9, wherein at least one annealing device is arranged to follow the spraying device, as seen in the substrate throughput direction (L).

14. The thermal and/or kinetic coating system as claimed in claim 9, wherein at least one cold rolling device is arranged to follow the spraying device, as seen in the substrate throughput direction (L).

15. The thermal and/or kinetic coating system as claimed claim 9, wherein a milling device is arranged to follow the spraying device, as seen in the strip movement direction.

16. A method for producing a coated substrate by means of a thermal and/or kinetic coating system, characterized by the following steps:
optionally pretreating the working side of the substrate;
linear and continuous passing through of the substrate beneath a spraying device, wherein the working side of the substrate, by means of a mask consisting of at least one rotating disk, the upper side of which is perpendicular to the flow of the coating material, or by means of a continuously revolving tape mask in the region of a spray jet, is partially covered and only partially subjected to deposition;
optionally in each case, at least one annealing, at least one cold rolling and a milling of the coating which is applied to the substrate.
